(19) United States
(12) Patent Application Publication
(10) Pub. No.: US 2003/0178201 A1
(43) Pub. Date: Sep. 25, 2003

(54) Method for inserting a pipe liner

(75) Inventors: Robert A. Gleim, Royersford, PA (US); John R. Wright JR., Devon, PA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Polyflow, Inc., Oaks, PA (US)

(21) Appl. No.: 10/393,902

(22) Filed: Mar. 20, 2003

Related U.S. Application Data
(60) Provisional application No. 60/365,850, filed on Mar. 20, 2002.
(60) Provisional application No. 60/405,620, filed on Aug. 23, 2002.

(51) Int. Cl. F16L 55/16

(52) U.S. Cl. 166/367; 405/184.2; 138/98

(57) ABSTRACT

A method of installing a self-supporting liner in a pipe section having an inner diameter DP. The liner includes a continuous tube of polymeric material, a braided sheath surrounding the tube, and an outer jacket surrounding the braided sheath. The liner has a relaxed outer diameter that is greater than DP. The diameter of the liner is temporarily reduced by applying a tensile load to the liner, which causes the braided sheath to radially compress the continuous tube of polymeric tubing. The liner is inserted into the pipe section while maintaining the radially-compressive force on the liner until the liner has been positioned along the desired length of the pipe section. The tensile load is then removed and the liner is maintained in the pipe section until the diameter of the pipe liner relaxes and forms an interference fit with the inner wall of the pipe section.

### CROSS REFERENCE TO RELATED APPLICATION(S)

This application is a regular application claiming priority to provisional application No. 60/365,850 filed Mar. 20, 2002, and provisional application No. 60/405,620 filed Aug. 23, 2002, both of which are incorporated herein by reference.

### FIELD OF INVENTION

The present invention relates to a method of installing a polymeric liner along the length of a fluid transfer pipe.

### BACKGROUND

Natural gas and petroleum wells usually comprise an exterior steel casing, which prevents the bore from collapsing, and an interior pipe or “production tube”, which conveys the natural gas or petroleum to the surface of the well. The production tube is suspended within the casing by a collar that connects the top of the production tube to the top of the casing. The collar positions the production tube concentrically within the casing so that an annular gap is formed between the exterior of the production tube and the interior of the casing.

Over the life-span of a well, the gradual reduction in well pressure causes a corresponding reduction in the exit velocity of the natural resource from the well through the production tube. In addition to reducing the productivity of the well, a reduction in the exit velocity below a critical value permits vaporized acids within natural gas to condense on the interior surface of the production tube.

After the exit velocity drops below an acceptable level, production from the well is boosted by inserting a reduced-diameter, co-axial velocity string within the production tube. Over the course of time, several additional reduceddiameter velocity strings may be installed until the well is tapped out.

Due to the highly-corrosive nature of oil and natural gas, and the inherently harsh subterranean conditions deep within the well, velocity strings must be made of a material having high corrosion resistance. Due to the high pressure of the fluids contained in the well, and the excessive weight of extreme lengths of the velocity string, the velocity string must also be made of a material having high strength.

It is known to make velocity strings from high strength carbon steel, such as AISI A606 and 4130. However, high strength carbon steel offers relatively low corrosion resistance to hydrocarbons and subterranean environments. As a result, high strength steel velocity strings must be replaced in as little as 9-12 months from installation.

Common steel velocity strings are also very heavy and require the use of expensive special equipment during installation. For example, a high tonnage crane is often needed to lift the steel supply coil which may weigh in excess of 20 tons. At off shore wells, specialized barges are needed to carry to the rig the steel supply coil, as well as a the high tonnage crane.

In the petrochemical industry, the transfer of oil, natural gas and other caustic fluids through the piping system of a processing plant also requires special consideration of the high pressures and corrosive nature of such fluids. As is the case with hydrocarbon wells, the weight and poor corrosion resistance of high strength carbon steel make it unacceptable for the piping system of a chemical or petrochemical processing plant.

As an alternative to high strength carbon steel, it is known in the chemical and petrochemical industries to install a polymeric liner within a steel pipe. This arrangement combines the corrosion resistance of the polymeric liner with the strength and low cost of the steel pipe. However, the conventional art has not developed a satisfactory way of inserting polymeric liners into steel piping. Sometimes, the steel piping can extend for a few miles. Also, the piping may only be accessible from one end, as is the case of a subterranean hydrocarbon well. Both of these conditions increase the difficulty of inserting a properly fitted liner into the steel piping.

One method of lining a steel pipe utilizes a polymeric liner having an outside diameter that is “undersized” or smaller than the inside diameter of the pipe. However, known undersized polymeric liners can not be used to line natural gas or oil wells for several reasons.

First, since the outside diameter of the liner is smaller than the inside diameter of the piping, undersized liners are incapable of being self supporting inside the vertically-extending production tube. Those polymeric materials that can withstand the corrosive effect of hydrocarbon products usually lack the tensile strength to be suspended at lengths required for oil and natural gas wells. Therefore, undersized liners are generally limited to installation in horizontally-aligned piping.

Second, the gap between an undersized liner and the carbon steel piping allows for the liner to expand radially during use due to the high pressure of liquids being transferred within the liner. Radial expansion can cause fractures in the liner which render the liner useless for protecting the piping from corrosion. Those polymeric materials that can withstand the corrosive effect of hydrocarbon products usually lack the hoop strength to withstand the continuous high pressure of a gas or oil well.

Another method of lining a pipe utilizes a polymeric liner having a relaxed outside diameter that is “oversized” or larger than the inside diameter of the casing. To insert an oversized polymeric liner, it must be passed through compression rollers that temporarily reduce the liner diameter. Typically, customized roller-reduction equipment must be fabricated for each pipe liner size.

Further, for proper installation, the reduced liner diameter must last long enough for installation along the entire length of the well. For deep wells, the diameter of the liner must not “relax” for several hours. The slow relaxation requirement severely limits the polymeric materials that may be used for oversize liners.

High density polyethylene is one known polymeric material that has a relaxation rate slow enough for making “oversized” liners. However, high density polyethylene can only be used in wells up to about 140° F. Further, high density polyethylene does not have the strength to be used in deep wells.

Therefore it would be desirable to provide a method of inserting a wide range of different polymeric liner materials in both horizontal and vertical piping.

### SUMMARY

The present invention relates to a self-supporting liner and method of installing the self-supporting liner in a pipe section having an inner diameter DP. In a preferred embodiment of the invention, the liner comprises a continuous tube of polymeric material, a braided sheath surrounding the tube, and an optional outer jacket surrounding the braided sheath. The liner has a relaxed outer diameter DL1 that is greater than DP.

In accordance with the method of the present invention, the relaxed diameter of the liner DL1 is temporarily reduced to a compressed diameter DL2 that is less than DP by applying a radially-compressive force along at least a portion of the length of the liner prior to inserting the liner in the pipe section. The radially-compressive force on the liner is achieved by applying a tensile load to the liner, which causes the braided sheath to radially compress the continuous tube of polymeric tubing.

The liner is fed into the pipe section while maintaining the radially-compressive force on the liner until the liner has been positioned along the desired length of the pipe section. The radially-compressive force is then removed from the pipe liner. At the same time, the liner is maintained in the pipe section until the diameter of the pipe liner relaxes and forms an interference fit with the inner wall of the pipe section.

When the liner is inserted into the vertical pipe section of a subterranean well, the tensile load is applied by connecting removable weights to the liner. The weights can be connected to the liner by inserting the weights into the end portion of the liner, and then connecting a cap to the down-hole end portion of the liner. Alternatively, the weights are connected to the liner by suspending the weights in the vertical pipe section, and then connecting the weights to the down-hole end portion of the liner. The tensile load is removed by disconnecting the weights from the liner. The weights are preferably disconnected by pulling the weights upwardly out of the liner and segmenting the down-hole end portion of the sheath to which the weights are connected. Alternatively, only the cap is segmented from the liner after the weights have been removed from the liner.

When the liner is inserted into one end of a horizontal pipe section, the tensile load is applied by connecting a cable to an end portion of the liner, extending the cable from one end of the pipe section to the other end of the pipe section, and applying a tensioning force to the cable from the distal end of the horizontal pipe section. The tensile load is removed by removing the tensioning force and disconnecting the cable from the end portion of the liner.

### BRIEF DESCRIPTION OF THE DRAWING(S)

FIG. 1 is a partial, broken, elevational view of a liner in accordance with an embodiment of the present invention;

FIG. 2 is an end view of the liner shown in FIG. 1; and,

FIG. 3 is a partial, broken, elevational end view of a liner in accordance with another embodiment of the invention.

### DETAILED DESCRIPTION OF THE PREFERRED EMBODIMENT(S)

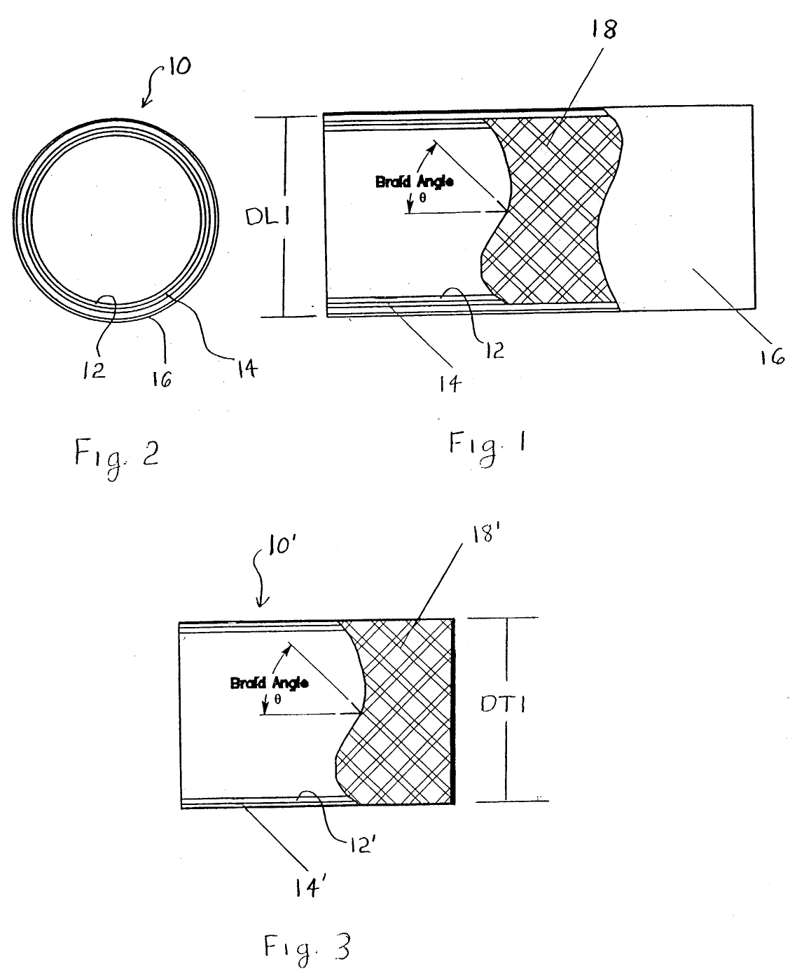

The method and apparatus of the present invention are described below with reference to FIGS. 1 and 2 wherein like reference numerals are used throughout to designate like elements.

A polymeric liner in accordance with a preferred embodiment of the present invention is shown in FIGS. 1 and 2 and is designated generally by reference numeral 10. The liner 10 is adapted to be inserted in both verticallyoriented and horizontally-oriented steel pipes such as the production tube of a well or the fluid transfer piping of a petrochemical plant. The liner 10 has a wide range of applications such as for use in pipes through which corrosive fluids, such as petrochemicals and hydrocarbons, are conveyed.

In a preferred embodiment, the liner 10 comprises a continuous tube of polymeric material 12, a braided sheath 14 surrounding the tube 12, and an outer jacket 16 surrounding the braided sheath 14. In the embodiment illustrated in FIG. 1, the liner 10 has a diameter DL1 in its natural or “relaxed” condition, which is greater than the inner diameter of the pipe DP in which the liner will be positioned. While the absolute values of DL1 and DP will vary, the difference between DL1 and DP should be large enough so that after installation, the interference fit between the liner 10 and the pipe allows the liner 10 to be self supporting in vertically-aligned pipes.

The continuous tube 12 can be fabricated from any polymeric material having properties compatible with the fluids flowing therethrough. For example, for use in a hydrocarbon well, the tube may be formed from a material, such as polyphenylene sulfide, which has high corrosion resistance and low permeation to natural gas and petroleum. For use in less caustic environments, the continuous tube may be formed from polyamide, such as sold under the mark Nylon, or a polyamide blend. The continuous tube 12 can be a multi-layer lining without departing from the scope of the present invention.

The braided sheath 14 is formed by a series of cross-braided fibers 18 that envelope the tube 12. The braided sheath 14 is preferably formed in a continuous coextrusion process wherein the cross-braided fibers 18 are introduced into the extruding process and are captured between the pipe 10 and the jacket 20. The braided sheath 14 extends along the entire length of the tube 12.

In the embodiment shown in FIGS. 1 and 2, the cross-braided fibers 18 comprise continuous filaments of a high-strength, braided, synthetic cordage such as the aramid yarns sold under the marks Kevlar® or Twaron®. However, other materials such as carbon fibers and polyester fibers can be used depending on the length of the liner. The sheath 14 is designed to impart a radially compressive load along the entire length of the tube 12 when a tensile load is applied to the sheath 14. As a result of the radially-inwardly compressive load, the diameter of the liner is compressed or reduced to a value DL2. Depending on the tubing material, the reduction in diameter from DL1 to DL2 is about 2 to about 5 percent depending on the diameter of the line.

Referring to FIG. 1, the fibers 18 are preferably woven at an angle relative to the longitudinal axis of the tube, referred to herein the braid angle θ. The braid angle θ can be adjusted to alter the amount of tensile load that must be applied to the ends of the braided sheath 14 to reduce the relaxed liner diameter DL1. It is preferred, but not necessary, that the braid angle θ be greater than forty-five degrees. When the braid angle θ is greater than fortyfive degrees, large radially compressive loads can be evenly distributed over the outer surface of the tube 12 using a relatively small tensile sheath load.

In the preferred embodiment, an outer jacket 16 is formed over the braided sheath 14 to protect the braided sheath 14 from damage during handling and installation. However, the jacket 16 is not required for the proper functioning of the liner 12.

The outer jacket 16 is preferably formed from a material that has low cost and high enough strength to protect the braided sheath from damage during installation and handling. For example, the exterior layer may comprise a polyamide material, sold under the mark Nylon® and Fortron®, or may be a blend of such materials. The outer jacket 16 is preferably at least 0.030 in. thick to prevent damage to the reinforcement fibers 18 during installation. In general, the outer jacket 16 may be thicker than 0.030 in. to provide a smooth exterior surface, which enhances installation into the pipe. The outer jacket 16 is preferably applied over the reinforcement fibers 18 during extrusion.

It is preferred that the weave density of the braided sheath 14 be sufficient to prevent bonding between the outer jacket 20 and the exterior of the pipe 10. If significant bonding between the jacket 20 and the pipe 10 occurs, the reinforcement fibers 18 will be prevented from shifting when the pipe is bent, thereby causing the pipe to kink rather than bend.

It is also preferred that any mechanical connection between the outer jacket 16 and the braided sheath 14 be minimized in order to allow relative movement therebetween. Thus, it is preferable that the outer jacket be attached to discrete, spaced apart portions of the braided sheath 14 rather than being evenly attached over the entire braided sheath 14. If significant bonding between the jacket 16 and the sheath 14 occurs, the sheath 14 will be prevented from radially contracting and expanding when a tensile load is applied and removed, respectively, from the sheath 14. Thus, the fibers 18 of the braided sheath 14 should be coated with, for example, a wax resin to allow for some slippage between the fibers 18 to facilitate maximum sheath diameter reduction with a minimum amount of force.

In another embodiment of the invention shown in FIG. 3, the liner 10′ is the same as the liner 10 described above except the liner 10′ does not have an outer jacket. In this embodiment, the diameter of the tube 12′ in the relaxed condition DT1 is preferably smaller than the diameter of the pipe DP into which the liner 10′ will be inserted. In the same manner as described above, the sheath 14′ is designed to impart a radially-inwardly compressive load along the entire length of the tube 12′ when a tensile load is applied to the sheath 14′. As a result of the radially-inwardly compressive load, the diameter of the tube 10′ is compressed or reduced to a value DT2.

The liner 10 of the present invention can be easily installed in both horizontal and vertical piping. The methods of installing the liner 10 described below may be used in conjunction with any of the embodiments of the liner 10 described above. For example, while a jacketed liner 10 may provide smoother sliding action between the liner 10 and the pipe, the methods can be used equally with a liner having no jacket.

In accordance with the method of the present invention, a liner 10 having a relaxed outer diameter DL1 that is greater than the diameter of the pipe DP is easily installed in both vertically-extending or horizontally-extending piping. The diameter of the liner 10 is initially temporarily reduced to a compressed diameter DL2 that is less than DP by applying a tensile load on the liner 10, which causes the braided sheath to exert a radially-inwardly compressive force on the continuous tube 12. The liner 10 is then inserted into one end of the pipe section until the liner is positioned along the desired length of the pipe section. During insertion of the liner into the pipe section, the tensile load on the liner 10 is maintained so that the radially-inwardly compressive force of the braided sheath 14 is also maintained, thereby preventing the diameter of the liner 10 from relaxing. Once the liner has been positioned along the desired length of the pipe section, liner is temporarily secured thereto while the radially-inwardly compressive force on the pipe is removed by removing the radial load on the liner 10. The diameter of the tube 12 then relaxes until it contacts or interferes with the inner wall of the pipe. The liner remains positioned in the pipe due to the interference fit between the liner 10 and the inner wall of the pipe. In the case of installation in a vertically-extending pipe, the liner is self-supporting.

The step of applying a tensile load to the liner can be achieved in several ways depending on the orientation of the pipe, and whether both ends of the pipe section are accessible by the installer. The methods of applying a tensile load are the same for a jacketed liner 10 or a liner without a jacket 10′.

The method of the present invention allows easy installation in a vertically-extending production tube of, for example, a hydrocarbon well. In this application, only one end (at the surface) of the production tube is accessible. In a preferred embodiment, an end portion of the liner 10 is initially removed from a spool supporting the coiled liner. In one embodiment, weights are then inserted into the liner and secured therein by applying a cap to the end of the liner 10. Alternatively, other ballast such as water can be loaded into the end of the liner.

The end portion of the liner 10 is then suspended from a crane to create a tensile load on the liner 10 which temporarily compresses the diameter of the liner to a size which allows easy insertion into the pipe. The compressed liner 10 is then fed downwardly into the pipe.

Once the liner 10 is fully inserted into the vertical pipe, a portion of the liner extending out from the vertical pipe is severed from the spool and secured. The weights are “fished” upwardly out of the liner. After the weights are removed, the cap on the down-hole end of the liner is sliced off using a cutter, which is slid downwardly into the pipe liner 12.

In another embodiment of the method of the present invention, weights are suspended from the end of the liner, instead of being placed in the interior of the liner. This method is preferred for long pipe runs with which a large amount of weight is required to compress the liner.

The method of the present invention also allows easy installation in a horizontally-extending pipe such as piping in a petrochemical factory. In accordance with this method, the tensile load is applied to the end portion of the liner by connecting a cable to the liner, extending the cable from one end of the pipe section to the other end of the pipe section, and applying a tensioning force to the cable from the distal end of the horizontal pipe section. After the liner is positioned in the desired portion of the horizontal pipe, the tensile load is removed by removing the tensioning force and disconnecting the cable from the liner.

The methods of the present invention do not require any specialized installation equipment, such as roller machinery. Because the sheath maintains a radially-compressive load on the liner during installation, the liner need not be made of a material having a slow relaxation rate. As a result, a wide range of materials, which have very smooth extruded surfaces, can be used for the tube 12 to maintain a flow rate over time that is better than stainless steel piping having a polished interior. For example, after a few months of use, the liner of the present invention allows liquid to flow at a rate two to three times better than through polished steel pipe. The increased flow rate significantly increases manufacturing efficiency for oil producers and other chemical processors.

While preferred embodiments of the present invention have been described in detail above, the present invention is not limited to the specific embodiments described herein which should be considered as merely exemplary. Further modifications and extensions of the present invention may be developed and all such modifications are deemed to be within the spirit and scope of the present invention.

What is claimed is:

1. A method of installing a self-supporting liner in a pipe section having an inner diameter DP, comprising the steps of:
a) providing a composite liner including a continuous tube of polymeric material, a braided sheath surrounding the tube, and an outer jacket surrounding the braided sheath, said liner having a relaxed outer diameter DL1 that is greater than DP;
b) temporarily reducing the relaxed diameter DL1 to a compressed diameter DL2 that is less than DP by applying a radially-compressive force along at least a portion of the length of the liner prior to inserting the liner in the pipe section;
c) inserting the liner into the pipe section;
d) maintaining the radially-compressive force on the liner until the liner has been positioned along the desired length of the pipe section;
e) removing the radially-compressive force from the pipe liner; and,
f) maintaining the pipe liner in the pipe section until the diameter of the pipe liner relaxes and forms an interference fit with the inner wall of the pipe section.

2. The method recited in claim 1, wherein the step of applying a radially-compressive force comprises applying a tensile load to the liner, which causes the braided sheath to radially compress the continuous tube of polymeric tubing.

3. The method recited in claim 2, wherein the step of maintaining the radially-compressive force comprises maintaining the tensile load on the liner.

4. The method recited in claim 3, wherein the liner is inserted into the vertical pipe section of a subterranean well, and the tensile load is applied by connecting removable weights to the liner.

5. The method recited in claim 4, wherein the tensile load is removed by disconnecting the weights from the liner.

6. The method recited in claim 5, wherein the tensile load is removed by segmenting the down-hole end portion of the sheath to which the weights are connected.

7. The method recited in claim 6, wherein the weights are connected to the liner by inserting the weights into the end portion of the liner, and connecting a cap to the down-hole end portion of the liner.

8. The method recited in claim 7, wherein the weights are disconnected by pulling the weights upwardly out of the liner.

9. The method recited in claim 8, including the step of disconnecting the cap from the liner after the weights have been removed from the liner.

10. The method recited in claim 6, wherein the weights are connected to the liner by suspending the weights in the vertical pipe section, and then connecting the weights to the down-hole end portion of the liner.

11. The method recited in claim 3, wherein the liner is inserted into one end of a horizontal pipe section, and the tensile load is applied by connecting a cable to an end portion of the liner, extending the cable to the other end of the pipe section, and applying a tensioning force to the cable from the other end of the horizontal pipe section.

12. The method recited in claim 11, wherein the tensile load is removed by removing the tensioning force and disconnecting the cable from the end portion of the liner.

13. The method recited in claim 1, including the step of arranging the fibers of the braided sheath so that the braid angle “theta” is greater than 45 degrees.

14. The method recited in claim 1, including the step of tensioning the liner to compress the diameter of the liner from DL1 to DL2, winding the liner under tension on a spool at a location remote from the pipe section, and then delivering the spool of compressed liner to the pipe section.

15. A method of lining a pipe section having an inner diameter DP, comprising the steps of:
a) providing a continuous length of polymeric tubing having the desired properties for lining the pipe section and having a relaxed outer diameter DT1 that is greater than DP;
b) temporarily reducing the relaxed diameter DT1 to a compressed diameter DT2 that is less than DP by applying a radially-compressive force along the length of the tubing prior to inserting the tubing in the pipe;
c) inserting the tubing into the pipe section;
d) maintaining the radially-compressive force on the tubing until the tubing has been positioned along the desired length of the pipe section;
e) removing the radially-compressive force from the tubing; and,
f) maintaining the tubing in the pipe section until the diameter of the tubing relaxes and forms an interference fit with the inner wall of the pipe section.

16. The method recited in claim 15, wherein the radially-compressive force is applied to the tubing by enveloping the tubing with a braided sheath that exerts a radially- compressive force on the tubing when tensile force is applied to the sheath.

17. The method recited in claim 16, wherein the sheath envelops the entire length of the tubing.

18. The method recited in claim 15, wherein the tubing is made of a polymeric material which returns from its compressed diameter to its relaxed diameter in about 1 minute or less.

19. The method recited in claim 16, wherein the step of maintaining the radially-compressive force comprises maintaining the tensile load on the tubing.

20. The method recited in claim 16, including the step of protecting the braided sheath during insertion of the liner into the pipe section by covering the braided sheath with a protective jacket.

21. A method of manufacturing a self-supporting liner for a pipe section having inner diameter equal to DP, comprising the steps of:
a) extruding a continuous length of polymeric tubing having a outer diameter DL that is greater than DP; and,
b) applying a braided sheath over the length of the tubing during extrusion,
wherein the braided sheath exerts an inwardly compressive force on the pipe when a tensile force is applied to the sheath.

22. The method recited in claim 21, including the step of co-extruding and applying a polymeric jacket over the braided sheath.

23. The method recited in claim 21, wherein the braided sheath comprises a plurality of fibers which are arranged in a braid angle θ that is greater than about 45 degrees.

24. The method recited in claim 22, including the step of tensioning the sheath so that the relaxed diameter DT1 is reduced to a compressed diameter DT1 that is less than DP, and then winding the tubing under tension on a spool.

25. A self-supporting pipe liner for use in a hydrocarbon well pipe section having an inner diameter DP, comprising:
a) a continuous tube of polymeric material;
b) a braided sheath surrounding said continuous tube; and,
c) an outer jacket surrounding said reinforcement fibers.
wherein said liner has a relaxed outer diameter DL1 that is greater than DP, and wherein said braided sheath exerts a radially-inwardly compressive force on said tube when tensile force is applied to said braided sheath.

26. The pipe liner recited in claim 25, wherein said liner is co-extruded.

27. The pipe liner recited in claim 25, wherein said braided sheath comprises a plurality of fibers which are arranged at a braid angle θ that is greater than about 45 degrees.
